(19) United States
(12) Patent Application Publication
(10) Pub. No.: US 2020/0092882 A1
(43) Pub. Date: Mar. 19, 2020

(54) BASE STATION, BANDWIDTH ALLOCATION METHOD, WIRELESS COMMUNICATION SYSTEM AND TERMINAL

(71) Applicant: Panasonic Intellectual Property Management Co., Ltd., Osaka (JP)

(72) Inventors: Osamu KATO, Fukuoka (JP); Yasuhiro AOYAMA, Tokyo (JP); Mitsuru UESUGI, Kanagawa (JP)

(21) Appl. No.: 16/467,928

(22) PCT Filed: Nov. 22, 2017
(86) PCT No.: PCT/JP2017/041967

§ 371 Date: Jun. 7, 2019

(30) Foreign Application Priority Data
Jan. 17, 2017 (JP) 2017-005983

(51) Int. Cl. H04W 72/04; H04L 5/00; H04W 72/08; H04W 28/20

(52) U.S. Cl. CPC H04W 72/0453; H04L 5/0007; H04W 28/20; H04W 72/082; H04W 72/085; H04L 5/006

(57) ABSTRACT

Channel interference is suppressed, and an increase in the cost of manufacturing a terminal or in maximum transmission power is adaptively suppressed. A base station retains information relating to at least one already-allocated bandwidth, among all bandwidths that are to be used for wireless communication, in a memory and determines whether the already-allocated bandwidth that is the same as a bandwidth which satisfies terminal performance information, according to a request for communication from a terminal, which includes the terminal performance information is present or absent. In a case where the already-allocated bandwidth that is the same as the bandwidth which satisfies the terminal performance information is absent, the base station determines whether a non-allocated bandwidth that is the same as the bandwidth which satisfies the terminal performance information is present or absent. In a case where the non-allocated bandwidth that is the same as the bandwidth which satisfies the terminal performance information is present, the base station allocates the non-allocated bandwidth that is the same as the bandwidth which satisfies the terminal performance information, for the wireless communication with the terminal.

### TECHNICAL FIELD

The present disclosure relates to a base station, a bandwidth allocation method, and a wireless communication system that allocate a frequency bandwidth to a terminal that is a wireless communication partner, and a terminal to which the frequency bandwidth is allocated by the base station.

### BACKGROUND ART

For example, the Institute of Electrical and Electronic Engineers (IEEE) 802.11ad is known as a wireless standard that uses a milli-wave band (for example, a 60 GHz band) which is a high frequency band for wireless communication between a base station and a terminal (for example, refer to NPL 1).

In the wireless standard IEEE 802.11ad, a wireless frequency bandwidth (BW) is defined as being high. For example, there has been a discussion of defining a bandwidth (BW) as 2.16 GHz in the wireless standard IEEE 802.11ad and a bandwidth (BW) as a broad bandwidth that is equivalent to 400 MHz, 800 MHz, or the like in the 5-th mobile communication system (5G) wireless standard. However, in this case, the number of carrier wave frequencies is only small (3 (for example, in U.S.A) or 4 (for example, in Japan) (refer to FIG. 5A that will be referred to below) in the wireless standard IEEE 802.11ad).

### CITATION LIST

### Non-Patent Literature

[NPL 1] John Harmon, Wireless Application Marketing Microwave Communication Division, ‘Understanding IEEE 802.11ad Physical Layer and Measurement Challenges’, [online], May 2014, IEEE, pp. 13, 14, 16, 33, 53, [Search on Jan. 16, 2017], the Internet <URL:http://www.keysight.com/upload/cmc_upload/All/22May2014Webcast.pdf?& cc=JP&lc=jpn>

### SUMMARY OF THE INVENTION

For example, when the number of carrier wave frequencies is small in the wireless standard such as IEEE 802.11ad, the following problems are present.

For example, in a case where base stations that support a milli-wave band such as a band of 60 GHz are installed at a high density in an area, the same channel interference (interference between radio waves in the same frequency band) is difficult to suppress. For this reason, the same channel interference is difficult to adjust particularly among different base-station installation telecommunications carriers. If the number of carrier frequencies is great, carrier wave frequencies that are to be used can be divided autonomously in a distributed manner among base stations, but if the number of carrier frequencies is small, the same channel interference is difficult to adjust. Furthermore, the milli-wave band is effective in application not only to communication over an access line (more precisely, a line between a base station and a terminal) but also to communication over a backhaul (BH) line (more precisely, a line between a base station and a core network). This is because in the milli-wave band, a transfer speed is increased in order that a bandwidth can be secured broadly. However, when the number of carrier frequencies is small, in the same manner, the same channel interference is also difficult to suppress between backhaul lines without being limited to the access line.

Furthermore, in a case where the backhaul line is configured with a multi-hop between base stations instead of a single hop, required throughput of a wireless link at the origin (more precisely, the base station side that is connected directly to a core network) of a multi-hop path needs to be higher than required throughput of a wireless link of an endpoint (more precisely, the base station side that needs a great number of hops to make a connection to the core network, which is farthest from a base station that is connected directly to the core network) on the multi-hop path. However, in the wireless standard that is current IEEE 802.11ad, the number of carrier wave frequencies is small and a bandwidth is also stipulated as 2.16 GHz. Because of this, a carrier wave frequency of 2.16 GHz has to be allocated, as a bandwidth, to a wireless link for an endpoint. For this reason, in a case where multiple multi-hop paths are complicatedly configured, the same carrier wave frequency is allocated in the neighborhood, and the problem of the same channel interference, which is described above, is difficult to avoid.

Furthermore, the required throughput (bit per second (bps)), for example, is approximately 30 to 60 Mbps even in the case of transfer of a 4K image, and is more than enough in comparison with throughput (for example, approximately 385 Mbps even in the case of MCS1 (refer to a description that will be provided below)) in the wireless standard IEEE 802.11ad, in compliance of which a bandwidth of 2.16 GHz is allocated. However, in the wireless standard that is current IEEE 802.11ad, a bandwidth that is allocated to the terminal is only 2.16 GHz. Because of this, the terminal has to include a communication circuit that handles a wireless signal which uses a bandwidth of 2.16 GHz. This leads to an increase in the cost of manufacturing the terminal and an increase in maximum transmission power of the terminal.

An object of the present disclosure, which is made in view of the above-described situation in the related art, is to provide a base station, a bandwidth allocation method, a wireless communication system, and a terminal that are capable of allocating various bandwidths for wireless communication, of suppressing the same channel interference when performing the wireless communication, and of adaptively suppressing an increase in the cost of manufacturing the terminal or in maximum transmission power.

According to an aspect of the present disclosure, there is provided a base station that is capable of wireless communication that uses a high frequency band, the base station including: a memory in which information relating to at least one already-allocated bandwidth, among all bandwidths that are to be used for the wireless communication, is retained; and a processor that determines whether the already-allocated bandwidth that is the same as a bandwidth which satisfies terminal performance information is present or absent, according to a request for communication from a terminal, which includes the terminal performance information, determines whether a non-allocated bandwidth that is the same as the bandwidth which satisfies the terminal performance information is present or absent, in a case where the already-allocated bandwidth that is the same as the bandwidth which satisfies the terminal performance information is absent, and allocates the non-allocated bandwidth that is the same as the bandwidth which satisfies the terminal performance information, for the wireless communication with the terminal, in a case where the non-allocated bandwidth that is the same as the bandwidth which satisfies the terminal performance information is present.

Furthermore, according to another aspect of the present disclosure, there is provided a bandwidth allocation method in a base station that is capable of wireless communication that uses a high frequency band, the method including: a step of retaining information relating to at least one already-allocated bandwidth, among all bandwidths that are to be used for the wireless communication, in a memory; a step of determining whether the already-allocated bandwidth that is the same as a bandwidth which satisfies terminal performance information is present or absent, according to a request for communication from a terminal, which includes the terminal performance information; a step of determining whether a non-allocated bandwidth that is the same as the bandwidth which satisfies the terminal performance information is present or absent, in a case where the already-allocated bandwidth that is the same as the bandwidth which satisfies the terminal performance information is absent; and a step of allocating the non-allocated bandwidth that is the same as the bandwidth which satisfies the terminal performance information, for the wireless communication with the terminal, in a case where the non-allocated bandwidth that is the same as the bandwidth which satisfies the terminal performance information is present.

Furthermore, according to still another aspect of the present disclosure, there is provided a wireless communication system including: at least one terminal; and a base station that is capable of wireless communication with the terminal, which uses a high frequency band, in which the terminal transmits a request for communication, which includes terminal performance information of the terminal itself, to the base station, and in which the base station retains information relating to at least one already-allocated bandwidth, among all bandwidths that are to be used for the wireless communication, in a memory, determines whether the already-allocated bandwidth that is the same as a bandwidth which satisfies the terminal performance information is present or absent, according to the request for the communication, which is transmitted from the terminal, determines whether a non-allocated bandwidth that is the same as the bandwidth which satisfies the terminal performance information is present or absent, in a case where the already-allocated bandwidth that is the same as the bandwidth which satisfies the terminal performance information is absent, and allocates the non-allocated bandwidth that is the same as the bandwidth which satisfies the terminal performance information, for the wireless communication with the terminal, in a case where the non-allocated bandwidth that is the same as the bandwidth which satisfies the terminal performance information is present.

Furthermore, according to still another aspect of the present disclosure, there is provide a terminal that wirelessly communicates with a base station that is capable of the wireless communication that uses a high frequency band, the terminal including: a memory in which terminal performance information of the terminal itself that includes information relating to a bandwidth in which the terminal is operable, among all bandwidths that are to be used for the wireless communication, is retained; a processor that generates a request for communication with the base station, which includes the terminal performance information of the terminal itself; and a communication unit that transmits the request for the communication to the base station, in which, in the base station, it is determined whether an already-allocated bandwidth that is the same as a bandwidth which satisfies the terminal performance information is present or absent, in a case where the already-allocated bandwidth that is the same as the bandwidth which satisfies the terminal performance information is absent, it is determined whether a non-allocated bandwidth that is the same as the bandwidth which satisfies the terminal performance information is present or absent, and in a case where the non-allocated bandwidth that is the same as the bandwidth which satisfies the terminal performance information is present, the communication unit receives information relating to the non-allocated bandwidth that is the same as the bandwidth which satisfies the terminal performance information, which is transmitted from the base station, and in which the processor sets information relating to a bandwidth for the wireless communication with the base station, using the information relating to the non-allocated bandwidth that is the same as the bandwidth which satisfies the terminal performance information, which is transmitted from the base station.

According to the present disclosure, various bandwidths for wireless communication are allocable, the same channel interference can be suppressed when performing the wireless communication, and an increase in the cost of manufacturing the terminal or in maximum transmission power can be adaptively suppressed.

### BRIEF DESCRIPTION OF DRAWINGS

FIG. 1 is a diagram of an example of a system configuration of a wireless communication system according to the present embodiment.

FIG. 2 is a diagram illustrating an example of a frame format of a wireless signal and a wireless spectrum map in accordance with multiple types of clock frequencies.

FIG. 3 is a block diagram illustrating in detail an example of an internal configuration of a terminal according to the present embodiment.

FIG. 4 is a block diagram illustrating in detail an example of an internal configuration of a base station according to the present embodiment.

FIG. 5A is a diagram illustrating an example of allocation of a uniform wireless spectrum map in a wireless standard that is current WiGig (a registered trademark) or IEEE 802.11ad.

FIG. 5B is a diagram illustrating an example of allocation of various spectrum maps according to the present embodiment.

FIG. 6A is a diagram illustrating an example of a terminal category relating to the terminal according to the present embodiment.

FIG. 6B is a diagram illustrating an example of required throughput relating to the terminal according to the present embodiment.

FIG. 7 is a flowchart illustrating in detail an example of a procedure for processing that allocates a bandwidth in the base station according to the present embodiment.

FIG. 8 is a diagram illustrating an example of the wireless spectrum map that is allocated by operation of the base station that is illustrated in FIG. 7.

### DESCRIPTION OF EMBODIMENT

An embodiment (hereinafter referred to as “present embodiment) for specific disclosure of a base station, a bandwidth allocation method, a wireless communication system, and a terminal, which are according to the present disclosure, will be described below, suitably referring to the drawings. However, in some cases, a description more detailed than is necessary is omitted. For example, in some cases, a detailed description of an already-known matter or a duplicative description of substantially the same configuration may be omitted. The reason for this is to avoid unnecessary redundancy of the following description and to help a person of ordinary skill in the art to achieve easy understanding. The accompanying drawings and the following description are provided in order for a person of ordinary skill in the art to get a sufficient understanding of the present disclosure, and therefore, this is not intended to impose a limitation on a subject matter that is recited in a claim.

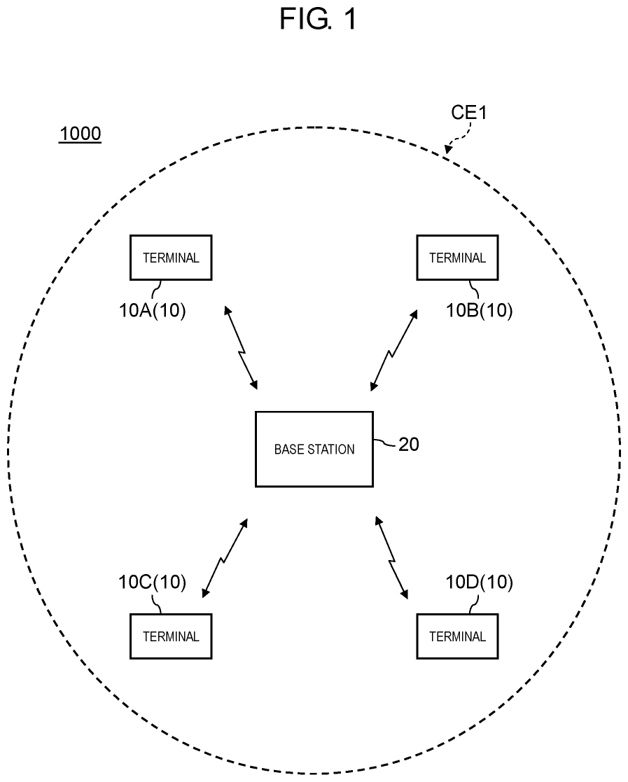

FIG. 1 is a diagram of an example of a system configuration of wireless communication system 1000 according to the present embodiment.

Wireless communication system 1000 is configured to include one or more terminals, terminals 10A, 10B, 10C, and 10D and base station 20. Terminals 10A, 10B, 10C, and 10D are the same in configuration, and thus are hereinafter collectively referred to “terminal 10”. Terminal 10 and base station 20 are communicably connected to each other. In FIG. 1, for brief description, four terminals, terminals 10A, 10B, 10C, and 10D, are illustrated, but the number of terminals that are connectable to and communicable with base station 20 in wireless communication system 1000 is not limited to 4.

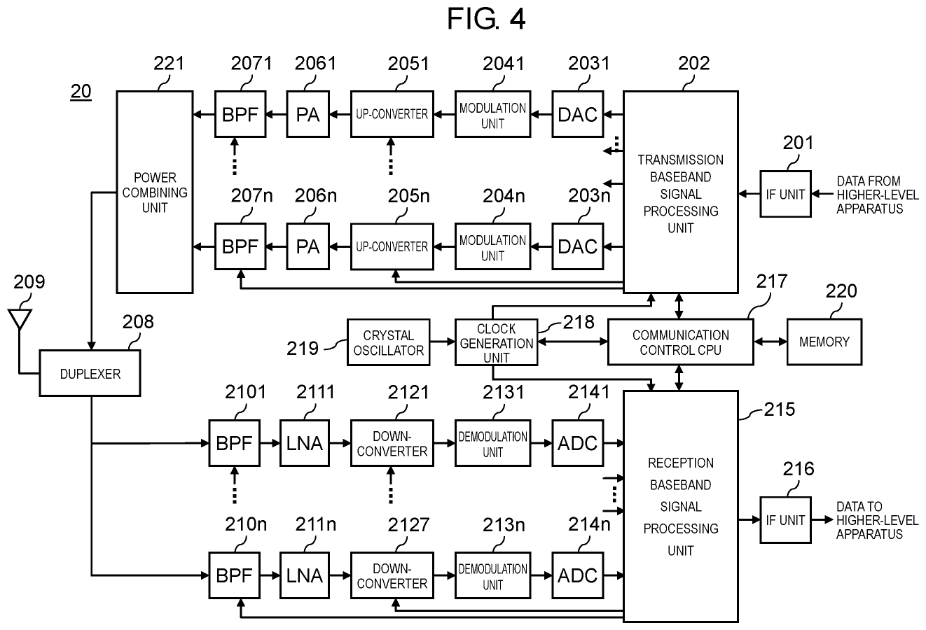

Base station 20 provides small cell CE1 that possibly realizes wireless communication in compliance with a prescribed wireless communication standard (for example, for a 60 GHz band that is represented by WiGig (a registered trademark) and IEEE 802.11ad, a milli-wave band, or a 28 GHz band of which the primary use for 5G (the 5-th mobile communication system)) that requires the use of a high frequency band. It is possible that base station 20 performs the wireless communication in the high frequency band (for example, a 60 GHz band) between of each of terminals 10A, 10B, 10C, and 10D that are present within small cell CE1. An internal configuration of base station 20 will be described in detail below with reference to FIG. 4.

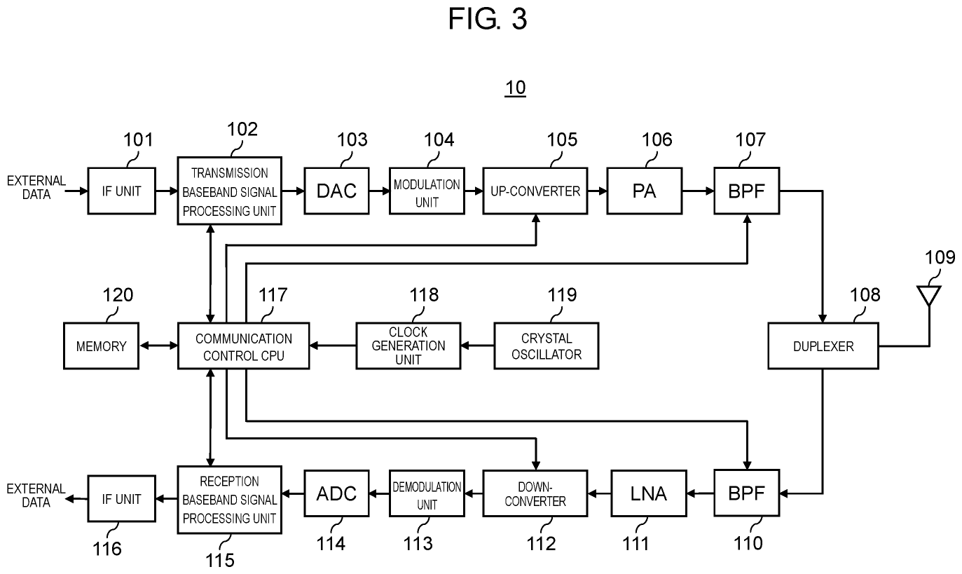

Terminal 10 is a terminal for data communication, which possibly performs the wireless communication in compliance with a prescribed wireless communication standard (for example, for a 60 GHz band that is represented by WiGig (a registered trademark) and IEEE 802.11ad, a milli-wave band, or a 28 GHz band of which the primary use for 5G (the 5-th mobile communication system)) that requires the use of the high frequency band, and for example, a smartphone, a portable telephone, or a tablet terminal. Furthermore, terminal 10 may be a monitoring camera that has a wireless module of which a configuration is illustrated in FIG. 3, or may be an autonomous driving vehicle. Furthermore, terminal 10 may be a portable foldable notebook personal computer (PC) or may be a simply-portable notebook PC. An internal configuration of terminal 10 will be described below with reference to FIG. 3.

Terminal 10 and base station 20, as described above, perform the wireless communication, complying with a prescribed wireless communication standard (for example, for a 60 GHz band that is represented by WiGig (a registered trademark) and IEEE 802.11ad, a milli-wave band, or a 28 GHz band of which the primary use for 5G (the 5-th mobile communication system)) that requires the use of the high frequency band. Furthermore, terminal 10 and base station 20 may perform the wireless communication that combinedly corresponds to any other wireless communication standards (for example, Long Term Evolution (LTE), LTE-Advanced, a wireless Local Area Network (LAN), Digital Enhanced Cordless Telecommunication (DECT), and the 3G mobile communication system (3G)).

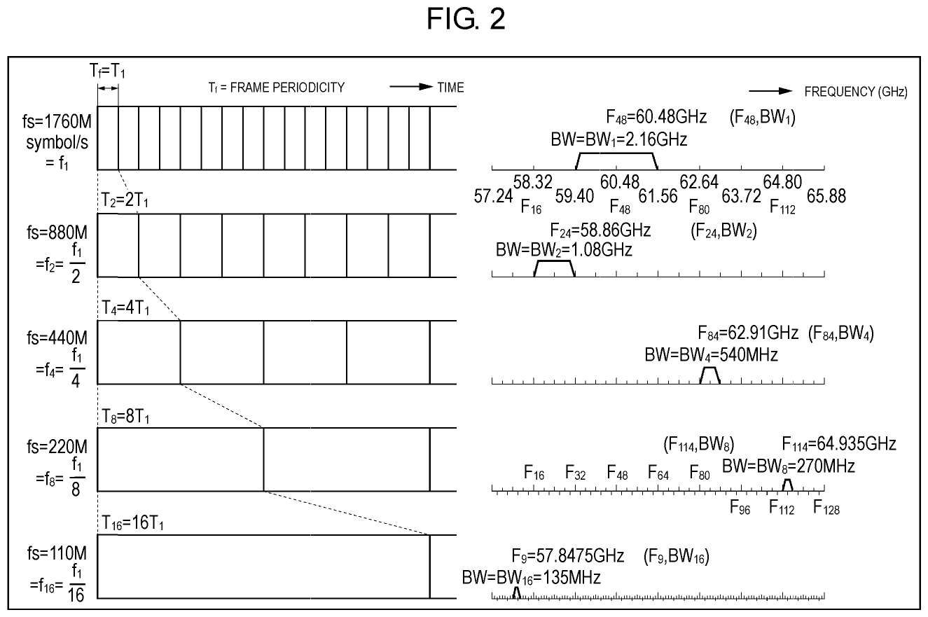

FIG. 2 is a diagram illustrating an example of a frame format of a wireless signal and a wireless spectrum map in accordance with multiple types of clock frequencies.

A total of five types of frame formats of the wireless signal in accordance with a clock frequency for operating terminal 10 and base station 20 are illustrated in the first to fifth rows along the time axis on the left side of a paper sheet where FIG. 2 is drawn. A total of five types of wireless spectrum maps in accordance with frame formats, respectively, on the left side of the paper sheet in FIG. 2 are illustrated in the first to fifth rows along the frequency axis on the right side of the paper sheet where FIG. 2 is drawn. A wireless communication standard that is WiGig (a registered trademark) or IEEE 802.11ad will be described illustratively below. However, it goes without saying that the present embodiment is not limited to these wireless communication standards.

In FIG. 2, 57.24 GHz to 65.88 GHz are illustrated as a frequency band (in other words, an entire bandwidth) that is used for WiGig (a registered trademark) wireless communication. Furthermore, in the description that is provided with reference to FIG. 2, a carrier wave central frequency Fⱼ is expressed using Equation (1). In Equation (1), j=1 to 128 where j is an integer. In the following description, in some cases, the carrier wave central frequency Fⱼ and a bandwidth BWᵢ are collectively referred to “carrier wave frequency”.

[Equation 1]

Fⱼ=57.24+0.0675j[GHz] (1)

As illustrated in the first row in FIG. 2, in a case where a wireless signal in the high frequency band is transmitted using bandwidth (BW₁)=2.16 GHz, in terminal 10 or base station 20, there is a need to operate a circuit for wireless communication, when clock frequency fₛ=1760 M (mega) symbols/second (f₁), and it is possible that a maximum of four carrier wave frequencies that are set to be in a bandwidth (BW₁)=2.16 GHz are occupied. In the first row in FIG. 2, for example, a wireless spectrum (F₄₈, BW₁) is illustrated in which F₄₈=60.48 GHz in a 59.40 GHz to 61.56 GHz bandwidth (BW₁)=2.16 GHz is defined as a carrier wave central frequency.

Therefore, in order to efficiently allocate a high frequency band of 57.24 GHz to 65.88 GHz for WiGig (a registered trademark) (in other words, in order to maximize a value that the carrier wave frequency takes without any waste), four carrier wave central frequencies Fⱼ that are desirably allocated are present as follows. Specifically, there are F₁₆ (more precisely, 58.32 GHz), F₄₈ (more precisely, 60.48 GHz), F₈₀ (more precisely, 62.64 GHz), and F₁₁₂ (more precisely, 64.80 GHz). This is possibly expressed as F₃₂ⱼ₋₁₆ (j=1, 2, 3, and 4) when a general equation is used where a value that the carrier wave frequency takes is defined as J.

As illustrated in the second row in FIG. 2, in a case where a wireless signal in the high frequency band can be transmitted using bandwidth (BW₂)=1.08 GHz, in terminal 10 or base station 20, if the circuit for wireless communication is caused to operate, when clock frequency fₛ=880 M (mega) symbols/second (=f₂=f₁/2), this is sufficient, and it is possible that a maximum of 8 carrier wave frequencies that are set to be in bandwidth (BW₂)=1.08 GHz are occupied. In the second row in FIG. 2, for example, a wireless spectrum (F₂₄, BW₂) is illustrated in which F₂₄=58.86 GHz in a 58.32 GHz to 59.40 GHz bandwidth (BW₂)=1.08 GHz is defined as the carrier wave central frequency.

Therefore, in order to efficiently allocate the high frequency band of 57.24 GHz to 65.88 GHz for WiGig (a registered trademark) (in other words, in order to maximize a value that the carrier wave frequency takes without any waste), eight carrier wave central frequencies Fⱼ that are desirably allocated are present as follows. Specifically, there are F₈ (more precisely, 57.78 GHz), F₂₄ (more precisely, 58.86 GHz), F₄₀ (more precisely, 59.94 GHz), F₅₆ (more precisely, 61.02 GHz), F₇₂ (more precisely, 62.10 GHz), F₈₈ (more precisely, 63.18 GHz), F₁₀₄ (more precisely, 64.26 GHz), and F₁₂₀ (more precisely, 65.34 GHz). This is possibly expressed as F₁₆ⱼ₋₈ (j=1, 2, 3, 4, 5, 6, 7, and 8) when a general equation is used where a value that the carrier wave frequency takes is defined as j.

As illustrated in the third row in FIG. 2, in a case where a wireless signal in the high frequency band can be transmitted using bandwidth (BW₄)=0.54 GHz=540 MHz, in terminal 10 or base station 20, if the circuit for wireless communication is caused to operate, when clock frequency fₛ=440 M (mega) symbols/second (=f₄=f₁/4), this is sufficient, and it is possible that a maximum of 16 carrier wave frequencies that are set to be in bandwidth (BW₄)=0.54 GHz are occupied. In the third row in FIG. 2, for example, a wireless spectrum (F₈₄, BW₄) is illustrated in which F₈₄=62.91 GHz in a 62.64 GHz to 63.18 GHz bandwidth (BW₄)=0.54 GHz is defined as a carrier wave central frequency.

Therefore, in order to efficiently allocate the high frequency band of 57.24 GHz to 65.88 GHz for WiGig (a registered trademark) (in other words, in order to maximize a value that the carrier wave frequency takes without any waste), 16 carrier wave central frequencies Fⱼ that are desirably allocated are present as follows. Specifically, there are F₄ (more precisely, 57.51 GHz), F₁₂ (more precisely, 58.05 GHz), F₂₀ (more precisely, 58.59 GHz), F₂₈ (more precisely, 59.13 GHz), F₃₆ (more precisely, 59.67 GHz), F₄₄ (more precisely, 60.21 GHz), F₅₂ (more precisely, 60.75 GHz), F₆₀ (more precisely, 61.29 GHz), F₆₈ (more precisely, 61.83 GHz), F₇₆ (more precisely, 62.37 GHz), F₈₄ (more precisely, 62.91 GHz), F₉₂ (more precisely, 63.45 GHz), F₁₀₀ (more precisely, 63.99 GHz), F₁₀₈ (more precisely, 64.53 GHz), F₁₁₆ (more precisely, 65.07 GHz), and F₁₂₄ (more precisely, 65.61 GHz). This is possibly expressed as F₈ⱼ₋₄ (j=1 to 16) when a general equation is used where a value that the carrier wave frequency takes is defined as j.

As illustrated in the fourth row in FIG. 2, in a case where a wireless signal in the high frequency band can be transmitted using bandwidth (BW₈)=0.27 GHz=270 MHz, in terminal 10 or base station 20, if the circuit for wireless communication is caused to operate, when clock frequency fₛ=220 M (mega) symbols/second (=f₈=f₁/8), this is sufficient, and it is possible that a maximum of 32 carrier wave frequencies that are set to be in bandwidth (BW₈)=0.27 GHz are occupied. In the fourth row in FIG. 2, for example, a wireless spectrum (F₁₁₄, BW₈) is illustrated in which F₁₁₄=64.935 GHz in a 64.80 GHz to 65.07 GHz bandwidth (BW₈)=0.27 GHz is defined as a carrier wave central frequency.

Therefore, in order to efficiently allocate the high frequency band of 57.24 GHz to 65.88 GHz for WiGig (a registered trademark) (in other words, in order to maximize a value that the carrier wave frequency takes without any waste), 32 carrier wave central frequencies Fⱼ that are desirably allocated are present as follows. Specifically, there are F₂ (more precisely, 57.375 GHz), F₆ (more precisely, 57.645 GHz), and so forth up to F₁₂₆ (more precisely, 65.745 GHz). This is possibly expressed as F₄ⱼ₋₂ (j=1 to 32) when a general equation is used where a value that the carrier wave frequency takes is defined as j.

As illustrated in the fifth row in FIG. 2, in a case where a wireless signal in the high frequency band can be transmitted using bandwidth (BW₁₆)=0.135 GHz=135 MHz, in terminal 10 or base station 20, if the circuit for wireless communication is caused to operate, when clock frequency fₛ=110 M (mega) symbols/second (=f₁₆=f₁/16), this is sufficient, and it is possible that a maximum of 64 carrier wave frequencies that are set to be in bandwidth (BW₁₆)=0.135 GHz are occupied. In the fifth row in FIG. 2, for example, a wireless spectrum (F₉, BW₁₆) is illustrated in which F₉=57.8475 GHz in a 57.78 GHz to 57.915 GHz bandwidth (BW₁₆)=0.135 GHz is defined as a carrier wave central frequency.

Therefore, in order to efficiently allocate the high frequency band of 57.24 GHz to 65.88 GHz for WiGig (a registered trademark) (in other words, in order to maximize a value that the carrier wave frequency takes without any waste), 64 carrier wave central frequencies Fⱼ that are desirably allocated are present as follows. Specifically, there are F₁ (more precisely, 57.3075 GHz), F₃ (more precisely, 57.4425 GHz), and so forth up to F₁₂₇ (more precisely, 65.745 GHz). This is possibly expressed as F₂ⱼ₋₁ (j=1 to 64) when a general equation is used where a value that the carrier wave frequency takes is defined as j.

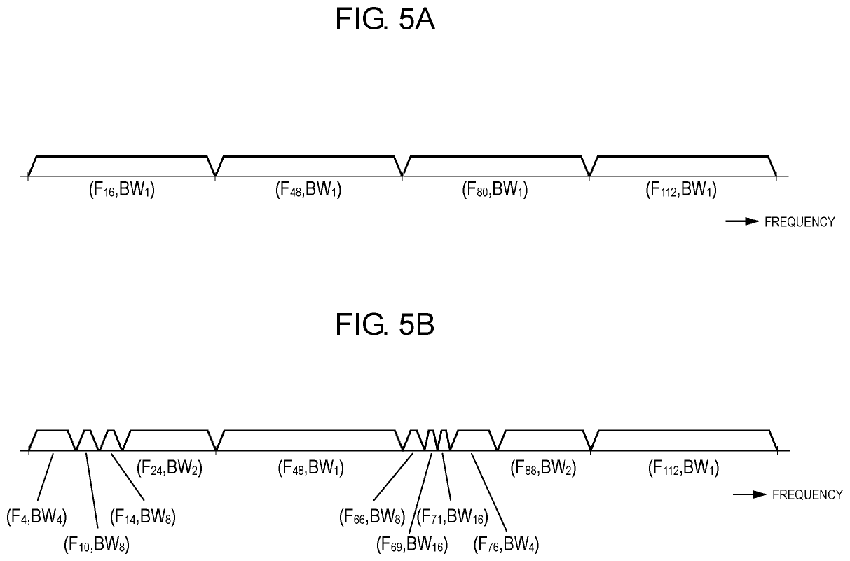

FIG. 5A is a diagram illustrating an example of allocation of a uniform wireless spectrum map in a wireless standard that is current WiGig (a registered trademark) or IEEE 802.11ad.

The horizontal axis in FIG. 5A illustrates a frequency. In the wireless communication standard that is current WiGig (a registered trademark) or IEEE 802.11ad, for example, as illustrated in FIG. 5A, a uniform wireless spectrum is allocated. Specifically, there are a wireless spectrum (F₁₆, BW₁) in which a carrier wave central frequency F₁₆ is in a bandwidth (BW₁)=2.16 GHz, a wireless spectrum (F₄₈, BW₁) in which the carrier wave central frequency F₁₆ is in the bandwidth (BW₁)=2.16 GHz, a wireless spectrum (F₈₀, BW₁) in which the carrier wave central frequency F₁₆ is in the bandwidth (BW₁)=2.16 GHz, and a wireless spectrum (F₁₁₂, BW₁) in which the carrier wave central frequency F₁₆ is in the bandwidth (BW₁)=2.16 GHz.

When a bandwidth is as high as 2.16 GHz, a transfer speed of approximately 385 Mbps is also obtained with Modulation and Coding Scheme (MCS) 1 in which a radio channel situation is not satisfactory, and a transfer speed of approximately 4620 Mbps is obtained with MCS 12 in which the radio channel situation is most satisfactory. More precisely, when a bandwidth of 2.16 GHz is used, a high speed transfer rate is obtained. However, when a bandwidth that is as high as 2.16 GHz is compared with a bandwidth of 135 MHz or 270 MHz, a momentary maximum amount (a peak value) of power consumption when a terminal or a base station, for example, generates a wireless signal is considerably large, and this leads to an increase in the cost of manufacturing the terminal or base stations, or to an increase in maximum transmission power.

Furthermore, in the wireless communication standard that is current WiGig (a registered trademark) or IEEE 802.11ad, in compliance with which only bandwidth=2.16 GHz can be allocated uniformly, the number of carrier wave frequencies is small, only 4 at a maximum. For this reason, for example, in a case where base stations that support a milli-wave band such as a band of 60 GHz are installed at a high density in an area, the same channel interference (interference between radio waves in the same frequency band) is difficult to suppress. Therefore, the same channel interference is difficult to adjust particularly among different base-station installation telecommunications carriers.

If the number of carrier frequencies is great, carrier wave frequencies that are to be used can be divided autonomously in a distributed manner among base stations, but if the number of carrier frequencies is small, the same channel interference is difficult to adjust. Furthermore, the milli-wave band is effective in application not only to communication over an access line (more precisely, a line between a base station and a terminal) but also to communication over a backhaul (BH) line (more precisely, a line between a base station and a core network). However, when the number of carrier frequencies is small, in the same manner, the same channel interference is also difficult to suppress between backhaul lines without being limited to the access line.

Moreover, in a case where the backhaul line is configured with a multi-hop between base stations instead of a single hop, required throughput of a wireless link at the origin (more precisely, the base station side that is connected directly to a core network) of a multi-hop path needs to be higher than required throughput of a wireless link of an endpoint (more precisely, the base station side that needs a great number of hops to make a connection to the core network, which is farthest from a base station that is connected directly to the core network) on the multi-hop path. However, in the wireless standard that is current WiGig (a registered trademark) or IEEE 802.11ad, the number of carrier wave frequencies is small and a bandwidth is also stipulated as 2.16 GHz. Because of this, a carrier wave frequency of 2.16 GHz has to be allocated, as a bandwidth, to a wireless link for an endpoint. For this reason, in a case where multiple multi-hop paths are complicatedly configured, the same carrier wave frequency is allocated in the neighborhood, and the problem of the same channel interference, which is described above, is difficult to avoid.

In the present embodiment, a solution (refer to FIG. 5B) to the problem, which is for base station 20 to allocate various wireless spectrums in a manner that conforms with terminal performance information (refer to a description thereof that will be provided below) of terminal 10, is described here.

FIG. 3 is a block diagram illustrating in detail an example of an internal configuration of terminal 10 according to the present embodiment.

Terminal 10 is configured to include interface (IF) unit 101, transmission baseband signal processing unit 102, digital to analog converter (DAC) 103, modulation unit 104, up-converter 105, power amplifier (PA) 106, band pass filter (BPF) 107, duplexer 108, and antenna 109. Furthermore, terminal 10 is configured to include BPF 110, low noise amplifier (LNA) 111, down-converter 112, demodulation unit 113, analog to digital converter (ADC) 114, reception baseband signal processing unit 115, and IF unit 116. Furthermore, terminal 10 is configured to include communication control central processing unit (CPU) 117 as an example of a processor, clock generation unit 118, crystal oscillator 119, and memory 120.

In terminal 10, IF unit 101, transmission baseband signal processing unit 102, DAC 103, modulation unit 104, up-converter 105, PA 106, BPF 107, duplexer 108, and antenna 109 forms a communication unit (a transmission unit) relating to transmission. Furthermore, duplexer 108, antenna 109, BPF 110, LNA 111, down-converter 112, demodulation unit 113, ADC 114, reception baseband signal processing unit 115, and IF unit 116 make up a communication unit (a reception unit) relating to reception. The communication by the communication unit of terminal 10 is controlled by communication control CPU 117.

IF unit 101, for example, is acquired data from a storage medium that is not illustrated, an operation unit that is not illustrated, or an application that is not illustrated, and the acquired data is delivered to transmission baseband signal processing unit 102.

Based on a control signal from communication control CPU 117, transmission baseband signal processing unit 102 performs various signal processing (baseband signal processing) operations in a baseband on data (external data) from IF unit 101. The baseband signal processing, for example, includes coding processing.

DAC 103 converts data (digital data) that goes through baseband signal processing, into an analog signal.

Modulation unit 104 modulates the analog signal from DAC 103 in compliance with a prescribed modulation scheme. Modulation schemes, for example, include orthogonal modulation. Orthogonal modulations include Quadrature Phase Shift Keying (QPSK) and Quadrature Amplitude Modulation (QAM).

Based on a carrier wave central frequency (UFⱼ) in an uplink (UL), which is set by communication control CPU 117, up-converter 105 increases a frequency of data in the baseband (BB band), which is modulated by modulation unit 104, and generates data in a high frequency (Radio Frequency (RF)) band (carrier wave frequency band).

PA 106 amplifies, for example, a signal power of data in the high frequency band from up-converter 105 and maintains a transmission power of a transmission signal including this data in such a manner that the transmission power is at a prescribed value that is a maximum value or lower. In some cases, PA 106 also maintains power density of the transmission signal in such a manner that the power density is at a prescribed value within an allowable range in compliance with the wireless communication standard.

Based on the carrier wave central frequency (UFⱼ) and a bandwidth (UBWᵢ) in the uplink, which are set by communication control CPU 117, BPF 107 performs filtering that allows a signal (transmission signal), within a bandwidth of which the center is the carrier wave central frequency, to pass through, and blocks signals other than the signal in such a bandwidth.

Duplexer 108, for example, is a component for sharing antenna 109 between a transmission system and a reception system in terminal 10. Duplexer 108 separates a signal that is received by antenna 109 and a signal that is transmitted from antenna 109.

Based on a communication band in compliance with the wireless communication standard that is employed by terminal 10 and a bandwidth (for example, a carrier wave central frequency (DFⱼ) and a bandwidth (DBWᵢ) in a downlink (DL), which are set by communication control CPU 117), BPF 110 performs filtering that allows a signal (reception signal), within a bandwidth of which the center is the carrier wave central frequency, to pass through, and blocks signals other than the signal in such a bandwidth.

LNA 111 amplifies a signal from BPF 110.

Based on the carrier wave central frequency (DFⱼ) in the downlink (DL), which is set by communication control CPU 117, down-converter 112 decreases a frequency of a signal (signal in the high frequency band) from LNA 111 and generates a signal in the baseband.

Demodulation unit 113 demodulates the data in the baseband from down-converter 112, in compliance with a prescribed demodulation scheme. The demodulation scheme, for example, includes orthogonal demodulation (for example QPSK and QAM) that corresponds to a modulation scheme.

ADC 114 converts the data (the analog signal) from demodulation unit 113 into digital data.

Reception baseband signal processing unit 115 performs the baseband signal processing on the data from ADC 114. The baseband processing, for example, includes decoding processing.

IF unit 116, for example, delivers the data (external data) from reception baseband signal processing unit 115, as external data, to various storage media, various display media, or various applications, which are not illustrated.

Communication control CPU 117 executes a program that is stored in a Read Only Memory (ROM), or a Random Access Memory (RAM) of memory 120, and thus performs various controls relating to wireless communication with base station 20.

Communication control CPU 117, for example, controls a call connection sequence in which terminal 10 and base station 20 performs the wireless communication. Communication control CPU 117, for example, performs control communication of user data (referred to simply as data communication) after the call connection sequence is performed. Communication control CPU 117, for example, performs control relating to handover (HO).

Communication control CPU 117 reads the terminal performance information (refer to the description thereof that will be provided below) that is stored in memory 120, from memory 120, and generates a request for communication with base station 20, which includes the terminal performance information. Communication control CPU 117 delivers the request for communication with base station 20 to transmission baseband signal processing unit 102. In the same manner as the external data that is delivered after actually starting the communication with base station 20, the request for communication is transmitted to base station 20 through the transmission unit (more precisely, transmission baseband signal processing unit 102, DAC 103, modulation unit 104, up-converter 105, PA 106, BPF 107, duplexer 108, and antenna 109).

Communication control CPU 117 acquires information relating to the carrier wave central frequencies and the bandwidths for the uplink and the downlink, which are allocated in the wireless communication with base station 20, through the reception unit (more precisely, antenna 109, duplexer 108, BPF 110, LNA 111, down-converter 112, demodulation unit 113, ADC 114, and reception baseband signal processing unit 115).

Communication control CPU 117 sets the carrier wave central frequency (UFⱼ) in the uplink (UL) to be for up-converter 105. Communication control CPU 117 sets the carrier wave central frequency (UFⱼ) and the bandwidth (UBWᵢ) in the uplink (UL) to be for BPF 107. In the present embodiment, the wireless communication standard that is WiGig (a registered trademark) which use a milli-wave band is touched on. Because of this, Time Division Duplex (TDD) is assumed, UFⱼ=DFⱼ, and UBWᵢ=DUBᵢ.

Communication control CPU 117 sets the carrier wave central frequency (DFⱼ) in the downlink (DL) to be for down-converter 112. Communication control CPU 117 sets the carrier wave central frequency (DFⱼ) and the bandwidth (DBWᵢ) in the downlink (DL) to be for BPF 110.

Based on a clock source from crystal oscillator 119, clock generation unit 118 generates an operating clock for a clock frequency at which terminal 10 operates. Clock generation unit 118, for example, multiplies a frequency of the clock source by prescribed times (for example, 200 times) and sets the resulting frequency to be a frequency of the operating clock (a clock frequency). Based on the control signal from communication control CPU 117, clock generation unit 118, for example, may dynamically change the clock frequency.

Crystal oscillator 119 generates the clock source having a prescribed frequency (for example, 13 MHz) and sends the generated clock source to clock generation unit 118.

Memory 120, for example, has a RAM as a working memory that is used when terminal 10 performs processing, and a ROM in which a program that specifies operation of terminal 10 and pieces of data are stored. Various pieces of data or information are temporarily stored in the RAM. The program is written to the ROM in which terminal 10 is specified. For example, the terminal performance information of the terminal itself is retained (stored) in memory 120.

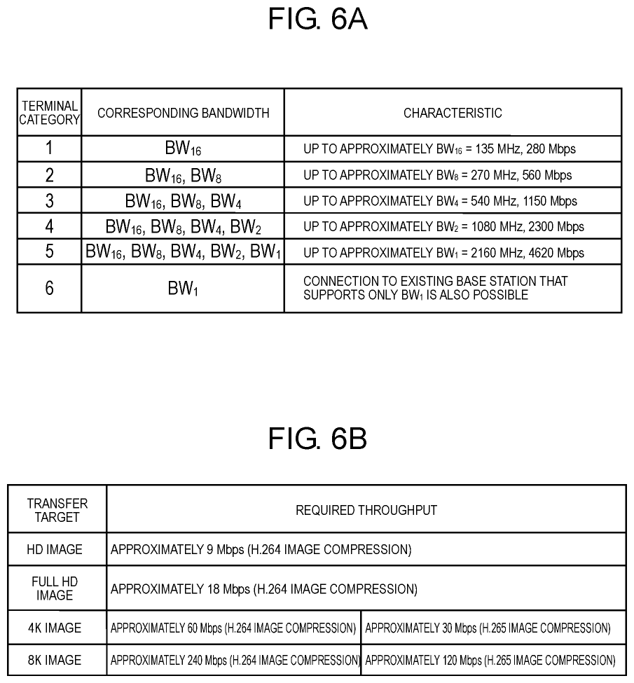

The terminal performance information is described here with reference to FIGS. 6A and 6B. The terminal performance information primarily has information relating to a terminal category and information relating to required throughput.

FIG. 6A is a diagram illustrating an example of the terminal category relating to the terminal according to the present embodiment. FIG. 6B is a diagram illustrating an example of the required throughput relating to the terminal according to the present embodiment.

FIG. 6A illustrates the terminal category, a bandwidth that corresponding to the terminal category, and a characteristic of the terminal category in a state of being associated with each other. The terminal category indicates information relating to a bandwidth in which the terminal is operable. For example, it is possible that in the wireless communication with base station 20, a terminal in Category “1” only operates in up to a bandwidth “BW₁₆” (more precisely, 135 MHz), and that the wireless communication at a maximum transfer speed of approximately 280 Mbps is performed.

For example, it is possible that in the wireless communication with base station 20, a terminal in Category “2” operates in the bandwidth “BW₁₆” (more precisely, 135 MHz) or in up to a bandwidth “BW₈” (more precisely, 270 MHz), and that the wireless communication at a maximum transfer speed of approximately 560 Mbps is performed.

For example, it is possible that in the wireless communication with base station 20, a terminal in Category “3” operates in the bandwidth “BW₁₆” (more precisely, 135 MHz), in the bandwidth of “BW₈” (more precisely, 270 MHz), or in up to a bandwidth of “BW₄” (more precisely, 540 MHz), and that the wireless communication at a maximum transfer speed of approximately 1150 Mbps is performed.

For example, it is possible that in the wireless communication with base station 20, a terminal in Category “4” operates in the bandwidth “BW₁₆” (more precisely, 135 MHz), in the bandwidth “BW₈” (more precisely, 270 MHz), in the bandwidth “BW₄” (more precisely, 540 MHz), or in up to a bandwidth “BW₂” (more precisely, 1080 MHz), and that the wireless communication at a maximum transfer speed of approximately 2300 Mbps is performed.

For example, it is possible that in the wireless communication with base station 20, a terminal in Category “5” operates in the bandwidth “BW₁₆” (more precisely, 135 MHz), in the bandwidth “BW₈” (more precisely, 270 MHz), in the bandwidth “BW₄” (more precisely, 540 MHz), in the bandwidth “BW₂” (more precisely, 1080 MHz), or in up to a “BW₁” (more precisely, 2160 MHz), and that the wireless communication at a maximum transfer speed of approximately 4620 Mbps is performed.

For example, it is possible that in the wireless communication with base station 20, a terminal in Category “6” only operates in the bandwidth “BW₁” (more precisely, 2160 MHz), and that the wireless communication at a maximum transfer speed of approximately 4620 Mbps is performed. However, it is possible that the terminal in Category “6” also makes a connection to an existing base station which supports the wireless communication that uses the bandwidth “BW₁” (more precisely, 2160 MHz).

In FIG. 6B, for example, in the wireless communication between terminal 10 and base station 20, an intended application for which transfer has to take place and required throughput (more precisely, throughput (a transfer speed) that is necessary to a minimum) that is necessary to be suitable for the intended application are illustrated in a state of being associated with each other.

Specifically, for transfer of high definition (HD) image data, which complies with the image compression standard H.264, as the required throughput, for example, a transfer speed of approximately 9 Mbps is required.

Specifically, for transfer of full high definition (HD) image data, which complies with the image compression standard H.264, as the required throughput, for example, a transfer speed of approximately 18 Mbps is required.

Furthermore, for transfer of 4K image data, which complies with the image compression standard H.264, as required throughput, for example, a transfer speed of approximately 60 Mbps is required, and, for transfer of 4K image data, which complies with the image compression standard H.265, for example, a transfer speed of approximately 30 Mbps is required.

For example, for transfer of 8K image data, which complies with the image compression standard H. 264, as the required throughput, for example, a transfer speed of approximately 240 Mbps is required, and for transfer of 8K image data, which complies with the image compression standard 11.265, for example, a transfer sped of approximately 120 Mbps is required.

In FIG. 6B, the reason for appending the word “approximately” to the required throughput is because, in some cases, the number of bits that are necessary for image coding differs, when considering a magnitude of motion within an image (for example, in a soccer game, a magnitude of motion is large and in a scenery image or the like, a magnitude of motion is comparatively small although flowers sway in the wind).

FIG. 4 is a block diagram illustrating in detail an example of an internal configuration of base station 20 according to the present embodiment.

Base station 20 is configured to include IF unit 201, transmission baseband signal processing unit 202, n DACs, DACs 2031 to 203n, n modulation units, modulation units 2041 to 204n, n up-converters, up-converters 2051 to 205n, n PAs, PAs 2061 to 206n, n BPFs, BPFs 2071 to 207n, power combining unit 221, duplexer 208, and antenna 209. Base station 20 is configured to include n BPFs, BPFs 2101 to 210n, n LNAs, LNAs 2111 to 211n, n down-converters, down-converters 2121 to 212n, n demodulation units, demodulation units 2131 to 213n, n ADCs, ADCs 2141 to 214n, reception baseband signal processing unit 215, and IF unit 216. Base station 20 is configured to include communication control CPU 217, clock generation unit 218, crystal oscillator 219, and memory 220.

In base station 20, IF unit 201, transmission baseband signal processing unit 202, n DACs, DACs 1031 to 103n, n modulation units, modulation units 1041 to 104n, n up-converters, up-converters 1051 to 105n, n PAs, PAs 1061 to 106n, n BPFs, BPFs 1071 to 107n, power combining unit 221, duplexer 208, and antenna 209 form a communication unit (a transmission unit) relating to transmission. Furthermore, duplexer 208, antenna 209, the n BPFs, BPFs 2101 to 210n, the n LNAs, LNAs 2111 to 211n, the n down-converters, down-converters 2121 to 212n, the n demodulation units, demodulation units 2131 to 213n, the n ADCs, ADCs 2141 to 214n, reception baseband signal processing unit 215, and IF unit 116 make up a communication unit (a reception unit) relating to reception. Communication by the communication unit of base station 20 is controlled by communication control CPU 217.

In base station 20, DACs, modulation units, up-converters, PAs, and BPFs, which are provided to make up the transmission unit, and BPFs, LNAs, down-converters, demodulation units, and ADCs that are provided to make up the reception unit are as many as n (more precisely, the number of terminals 10 with which base station 20 communicates, which is an integer that is equal to or greater than 1) in number. Of course, with the design or the like of a circuit configuration, it is possible that a value of n indicating the number of circuits is set to be low, rather than a value indicating the number of carrier wave frequencies that are to be allocated, but as many circuits as the number of carrier wave frequencies are illustrated here for in-principle description of operation.

IF unit 201, for example, acquires data from a higher-level apparatus that is not illustrated, and delivers the acquired data to transmission baseband signal processing unit 202. Furthermore, higher-level apparatuses, for example, include a core network, a Radio Network Controller (RNC), and a Serving Gateway (S-GW).

Based on the control signal from communication control CPU 217, transmission baseband signal processing unit 202 performs the baseband signal processing on the data from IF unit 201. The baseband signal processing, for example, includes the coding processing.

Each of the n DACs, DACs 2031 to 203n converts the data (digital data) that goes through the baseband signal processing, into an analog signal.

Each of the n modulation units, modulation units 2041 to 204n modulates the analog signal from DAC 203 according to the prescribed modulation scheme. Modulation schemes, for example, include orthogonal modulation. The orthogonal modulation, for example, includes QPSK and QAM.

Based on the carrier wave central frequency (DFⱼ) in the downlink (DL) for every terminal, which is set by communication control CPU 217, each of the n up-converters, up-converters 2051 to 205n increases a frequency of data in the baseband, which is modulated each of the n modulation units, modulation units 2041 to 204n, and generates data in the high frequency band.

Each of the n PAs, PAs 2061 to 206n, for example, amplifies a signal power of the data in the high frequency band from each of the n up-converters, up-converters 2051 to 205n, and maintains a transmission power of the transmission signal that includes the data in such a manner that the transmission power is constant. Each of the n PAs, PAs 2061 to 206n may maintain power density of the transmission signal in such a manner that the power density is constant.

Based on the carrier wave central frequency (DFⱼ) and the bandwidth (DBWᵢ) in the downlink (DL) for every terminal, which are set by communication control CPU 217, each of the n BPFs, BPFs 2071 to 207n performs filtering that allows a signal (transmission signal), within a bandwidth of which the center is the carrier wave central frequency to pass through, and blocks signals other than the signal in such a bandwidth.

Power combining unit 221 combines the transmission powers of the transmission signals that pass through the n BPFs, BPFs 2071 to 207n.

Duplexer 208, for example, is a component for sharing antenna 209 between a transmission system and a reception system in base station 20. Duplexer 208 separates a signal that is received by antenna 209 and a signal that is transmitted from antenna 209.

Based on the carrier wave central frequency (UFⱼ) and the bandwidth (UBWᵢ) in the uplink (UL) for every terminal, which are set by communication control CPU 217, each of the n BPFs, BPFs 2101 to 210n performs filtering that allows a signal (reception signal), within a bandwidth of which the center is the carrier wave central frequency to pass through, and blocks signals other than the signal in such a bandwidth.

Each of the n LNAs, LNAs 2111 to 211n amplifies the signal from each of the n BPFs, BPFs 2101 to 210n.

Based on the carrier wave central frequency (UFⱼ) in the uplink (UL) for every terminal, which is set by communication control CPU 217, each of the n down-converters, down-converters 2121 to 212n increases a frequency of a signal (signal in the high frequency band) from each of the n LNAs, LNAs 2111 to 211n, and generates a signal in the baseband.

Each of the n demodulation units, demodulation units 2131 to 213n demodulates the data in the base band from each of the n down-converters, down-converters 2121 to 212n according to the prescribed demodulation scheme. Demodulation schemes, for example, include orthogonal modulation. The orthogonal modulation, for example, includes QPSK and QAM.

Each of the n ADCs, ADCs 2141 to 214n converts the data (the analog signal) from each of the n demodulation units, demodulation units 2131 to 213n into digital data.

Reception baseband signal processing unit 215 performs the baseband signal processing on the data from each of the n ADCs, ADCs 2141 to 214n. The baseband signal processing, for example, include the decoding processing.

IF unit 216, for example, sends the data from reception baseband signal processing unit 215 to a higher-level apparatus that is not illustrated. Higher-level apparatuses, for example, include a core network, an RNC, and an S-GW.

Communication control CPU 217 executes a program that is stored in a ROM and a RAM of memory 220, and thus performs various controls relating to wireless communication with each of the terminals.

Communication control CPU 217, for example, controls a call connection sequence in which terminal 10 and base station 20 perform the wireless communication. Communication control CPU 217, for example, performs control communication of user data (referred to simply as data communication) after the call connection sequence is performed. Communication control CPU 217, for example, performs control relating to handover (HO).

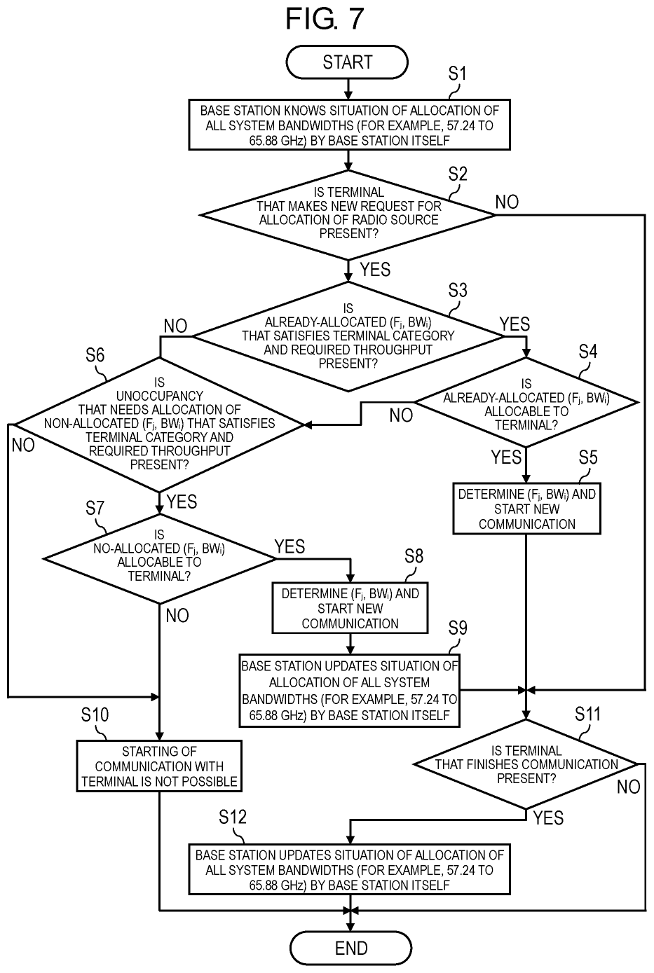

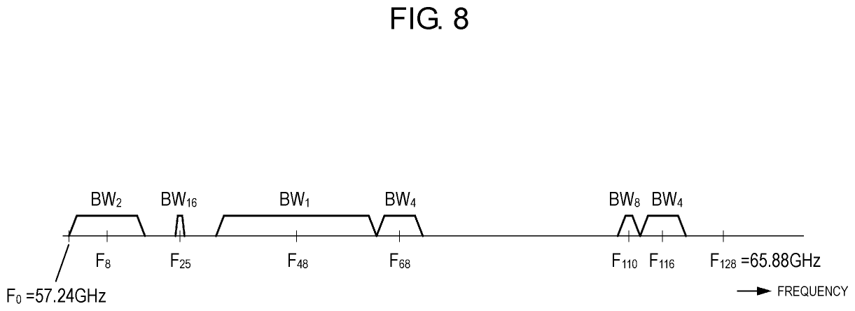

Communication control CPU 217 reads the terminal performance information (for example, the terminal performance information that is included in the request for communication, which has been from the terminal) that is stored in memory 220, from memory 220 and, based on the terminal performance information and information (refer to FIG. 5B or 8) relating to all bandwidths that are allocable by base station 20, determines whether or not the carrier wave central frequency and the bandwidth are allocated in the uplink and the downlink between the base station and the terminal that transmits the request for transmission. An example of the determination is described in detail with reference to FIG. 7.

In a case where it is determined that the carrier wave central frequency and the bandwidth are allocable in the uplink and the downlink between the base station and the terminal that transmits the request for transmission, communication control CPU 217 delivers information relating to the carrier wave central frequency and the bandwidth that are allocated in the uplink and the downlink, to transmission baseband signal processing unit 202. In the same manner that the external data that is delivered after actually starting the communication with terminal 10, this information is transmitted to terminal 10 through the transmission unit (more precisely, transmission baseband signal processing unit 202, the DAC that corresponds to the terminal, the modulation unit that corresponds to the terminal, the up-converter that corresponds to the terminal, the PA that corresponds to the terminal, the BPF that corresponds to the terminal, power combining unit 221, duplexer 208, and antenna 209).

Communication control CPU 217 sets the carrier wave central frequency (DFⱼ) for the downlink, which is allocated in the wireless communication with terminal 10, to be for the up-converter (more precisely, any one of the up-converters 2051 to 205n) in the transmission unit. Communication control CPU 217 sets the carrier wave central frequency (DFⱼ) and the bandwidth (DBWᵢ) for the downlink, which are allocated in the wireless communication with terminal 10, to be for the BPF (more precisely, any one of the BPFs 2071 to 207n).

Communication control CPU 217 sets the carrier wave central frequency (UFⱼ) for the uplink, which is allocated in the wireless communication with terminal 10, to be for the down-converter in the reception unit (more precisely, any one of the down-converters 2121 to 212n). Communication control CPU 217 sets the carrier wave central frequency (UFⱼ) and the bandwidth (UBWᵢ) for the uplink, which are allocated in the wireless communication with terminal 10, to be for the BPF (more precisely, any one of the BPFs 2101 to 210n).

Based on a clock source from crystal oscillator 219, clock generation unit 218 generates an operating clock for a clock frequency at which base station 20 operates. Clock generation unit 218, for example, multiplies a frequency of the clock source by prescribed times (for example, 200 times) and sets the resulting frequency to be a clock frequency. Based on the control signal from communication control CPU 217, clock generation unit 218, for example, may change the clock frequency. Specifically, clock generation unit 218 generates operating clocks for f₁ (=1760 M symbols/second), f₂ (=880 M symbol/second=f₁/2), f₄ (=440 M symbols/second=f₁/4), f₈ (=220 M symbols/second=f₁/8), and f16 (=110 M symbols/second f₁/16). Clock generation unit 218 outputs these operating clocks to transmission baseband signal processing unit 202 and reception baseband signal processing unit 215.

Crystal oscillator 219 generates the clock source having a prescribed frequency (for example, 13 MHz) and sends the generated clock source to clock generation unit 218.

Memory 220, for example, has a RAM as a working memory that is used when base station 20 performs processing, and a ROM in which a program that specifies operation of base station 20, and pieces of data are stored. Various pieces of data or information are temporarily stored in the RAM. Written to the ROM is a program that specifies the operation (for example, operation (processing) in a bandwidth allocation method according to the present disclosure) of base station 20.

FIG. 5B is a diagram illustrating an example of allocation of various wireless spectrum maps according to the present embodiment.

The horizontal axis in FIG. 5B represents a frequency. In the present embodiment, it is possible that base station 20 allocates wireless spectrums that have various variable carrier wave central frequencies and bandwidths, which is different from uniform fixed wireless spectrums (F₁₆, BW₁), (F₄₈, BW₁), (F₈₀, BW₁), and (F₁₁₂, BW₁) that are illustrated in FIG. 5A. As described above with reference to FIG. 5A, in the wireless communication standard that is current WiGig (a registered trademark) or IEEE 802.11ad, only a maximum of 4 carrier wave central frequencies can be occupied. BW₁=2.16 GHz.

On the other hand, in the present embodiment, based on the information relating to the bandwidth that is currently already allocated, of all bandwidths that are to be used for the wireless communication, base station 20 determines whether or not a bandwidth that satisfies the terminal performance information of terminal 10 is allocable. For the terminal performance information of terminal 10, as described with reference to FIGS. 6A or 6B, the baseband widths in which terminal 10 is operable, or types of required throughput are various and thus are not limited to being uniform. Therefore, as illustrated in FIG. 5B, wireless spectrums (F₄, BW₄), (F₁₀, BW₈), (F₁₄, BW₈), (F₂₄, BW₂), (F₄₈, BW₁) (F₆₆, BW₈),(F₆₉, BW₁₆), (F₇₁, BW₁₆), (F₇₆, BW₄), (F₈₈, BW₂), and (F₁₁₂, BW₁) are variously allocable by base station 20.

That is, 11 carrier wave central frequencies, for example, can be occupied, and there are also various bandwidths in each of the wireless spectrums. Each carrier wave central frequency Fⱼ is calculable using Equation (1). Furthermore, BW₂=1.08 GHz, BW₄=0.54 GHz, BW₈=0.27 GH, and BW₁₆=0.135 GHz.

FIG. 7 is a flowchart illustrating in detail an example of a procedure for processing that allocates a bandwidth in base station 20 according to the present embodiment. FIG. 8 is a diagram illustrating an example of the wireless spectrum map that is allocated by the operation of base station 20 which is illustrated in FIG. 7. The processing by the base station 20 that is illustrated in FIG. 7 is performed primarily by communication control CPU 217.

In FIG. 7, base station 20 has access to memory 220, and knows a situation of the allocation of the wireless spectrum for the carrier wave central frequency and the bandwidth by base statin 20 itself, among all system bandwidths (for example, 57.24 to 65.88 GHz) that are to be used for the wireless communication with the terminal which uses the high frequency band (refer to S1 and FIG. 8).

For example, base station 20 knows that (F₈, BW₂), (F₂₅, BW₁₆), (F₄₈, BW₁), (F₆₈, BW₄), (F₁₁₀, BW₈), and (F₁₁₆, BW₄) are completely allocated as the wireless spectrum map indicating a current situation of the allocation of the wireless spectrum for the carrier wave central frequency and the bandwidth by base station 20 itself, among all bandwidths (for example, 57.24 to 65.88 GHz). In other words, a total of 6 carrier wave frequencies, one carrier wave frequency in BW₁, one carrier wave frequency in BW₂, two carrier wave frequencies in BW₄, one carrier wave frequency in BW₈, and one carrier wave frequency in BW₁₆, are allocated. Base station 20 stores (retains) the situation of the allocation of the carrier wave frequency that is illustrated in FIG. 8, as management symbols (8, 2, 25, 16, 48, 1, 68, 4, 110, 8, 116, and 4), in memory 220.

At this point, base station 20 determines whether or not a terminal that makes a new request for allocation of a radio resource is present (S2). More precisely, base station 20 determines whether or not a communication request is received from the terminal which makes a new request for the communication with base station 20. In a case where it is determined that the terminal which makes the new request for the allocation of the radio resource is not present, the processing by base station 20 proceeds to Step S11.

On the other hand, in a case where it is determined that the terminal that makes the new request for the allocation of the radio resource (YES in S2), based on the terminal performance information (specifically, various pieces relating to the terminal category and the required throughput) that is included in the communication request which has been transmitted from the terminal, base station 20 determines whether or not the already-allocated carrier wave central frequency and bandwidth (hereinafter expressed as “(Fⱼ, BWᵢ)”) that satisfy the terminal category and the required throughput are present (S3).

In a case where, in the wireless spectrum map that is illustrated in FIG. 8, for example, a band (that is, BW₂ and BW₁) that is broader than BW₂ from the point of view of the required throughput is needed and where a terminal that is operable in the bandwidth BW₂ or narrower (that is, BW₂, BW₄, BW₈, and BW₁₆) from the point of view of the terminal category makes the communication request, it is determined in Step S3 that only (F₈, BW₂) is present as the already-allocated carrier wave central frequency and the bandwidth that satisfy the terminal category and the required throughput (YES in S3). In a case where, in the wireless spectrum map that is illustrated in FIG. 8, (F₈, BW₂) is not present as being already allocated (more precisely, (F₈, BW₂) is not allocated), a bandwidth that is equal to or broader than BW₂ is needed as the required throughput and only a bandwidth that is equal to or narrower than BW₂ can be available as the terminal category. Because of this, the already-allocated carrier wave central frequency and the bandwidth that satisfy the terminal category and the required throughput are not present (NO in S3).

Furthermore, in a case where it is determined that, in the wireless spectrum map that is illustrated in FIG. 8, for example, an operation is possible in bandwidths (that is, BW₂, BW₄, BW₈, and BW₁₆) that are equal to or narrower than BW₂, which are the same in the point of view of the terminal category, but in bandwidths (that is, BW₄, BW₂, and BW₁) that are equal to or broader than BW₄ from the point of view of the required throughput, it is determined that (F₈, BW₂), (F₆₈, BW₄), and (F₁₁₆, BW₄) are present (YES in S3).

In a case where it is determined that the already-allocated (Fⱼ, BWᵢ) which satisfies the terminal category and the required throughput is present (YES in S3), base station 20 determines whether or not the already-allocated (Fⱼ, BWᵢ) is allocable (more precisely, is unoccupied) on the time axis (S4).

In a case where it is determined that the already-allocated (Fⱼ, BWᵢ) is allocable (more precisely, is unoccupied) on the time axis (YES in S4), for new communication with the terminal that has transmitted the communication request in Step S2, base station 20 allocates the already-allocated (Fⱼ, BWᵢ) and starts the communication (S5). Subsequently to Step S5, the processing by base station 20 proceeds to Step S11.

On the other hand, in a case where it is determined that the already-allocated (Fⱼ, BWᵢ) that satisfy the terminal category and the required throughput is not present (NO in S3), or in a case where it is determined that the already-allocated (Fⱼ, BWᵢ) is present (YES in S3), but that the allocation is not possible (more precisely, is not unoccupied) on the time axis (NO in S4), the processing by base station 20 proceeds to Step S6.

Base station 20 determines whether or not the non-allocated (Fⱼ, BWᵢ) that satisfies the terminal category and the required throughput is present (more precisely, whether or not the wireless spectrum map in a current situation is unoccupied to such an extent that new (Fⱼ, BWᵢ) is allocated) (S6).

In a case where it is determined that non-allocated (Fⱼ, BWᵢ) that satisfies the terminal category and the required throughput cannot be allocated (more precisely, the wireless spectrum map in the current situation is not unoccupied to such an extent that new (Fⱼ, BWᵢ) is allocated) (NO in S6), it is not possible that the communication with the terminal that has transmitted the communication request in Step S2 is started (S10), and the processing by base station 20 is ended.

On the other hand, in a case where it is determined that the non-allocated (Fⱼ, BWᵢ) that satisfies the terminal category and the required throughput is present (more precisely, the wireless spectrum map in the current situation is unoccupied to such an extent that new (Fⱼ, BWᵢ) is allocated) (YES in S6), base station 20 determines that the non-allocated (Fⱼ, BWᵢ) is allocable to the terminal which has transmitted the communication request in Step S2 (S7). In Step S7, for example, base station 20 determines whether or not the allocation to the terminal that has transmitted the communication request in Step S2 is possible, according to whether or not signal interference occurs between base station 20 itself and any other neighboring base station. In a case where it is determined that there is a likelihood that the signal interference will occur between base station 20 itself and any other neighboring base station, base station 20 determines that the allocation of non-allocated (Fⱼ, BWᵢ) to the terminal that has transmitted the communication request in Step S2 is not possible (NO in S7). In a case where multiple non-allocated (Fⱼ, BWᵢ)'s that satisfy the terminal category and the required throughput are present, base station 20, as in Step S7, makes determinations of all non-allocated (Fⱼ, BWᵢ)'s that satisfy the terminal category and the required throughput. However, in a case where even one new allocable (Fⱼ, BWᵢ) is not present (NO in S7), base station 20 determines that the starting of the communication with the terminal which has transmitted the communication request in Step S2 is not possible (S10).

On the other hand, in a case where it is determined that there is no likelihood that the signal interference between base station 20 itself and any other neighboring base station, base station 20 determines that the allocation of non-allocated (Fⱼ, BWᵢ) to the terminal that has transmitted the communication request in Step S2 is possible (YES in S7). In this case, for new communication with the terminal that has transmitted the communication request in Step S2, base station 20 allocates the non-allocated (Fⱼ, BWᵢ) and starts the communication (S8). Subsequently to Step S8, base station 20 performs update in such a manner that (Fⱼ, BWᵢ) which is allocated in Step S8 is added to the wireless spectrum map indicating a current allocation situation of base station 20 itself, which is stored (retained) in memory 220 (S9).

In Step S11, base station 20 determines whether or not, among terminals 10 currently in communication with base station 20, a terminal that is going to finish the communication is present (S11). For example, in a case where a request for communication completion is received from terminal 10 currently in communication with base station 20, base station 20 determines whether or not, among terminals 10 currently in communication with base station 20, a terminal that is going to finish the communication is present (YES in S11). In a case where it is determined that, among terminals 10 currently in communication with base station 20, a terminal that is going to finish the communication is not present (NO in S11), the processing by base station 20 ends without causing any change.

On the other hand, in a case where it is determined that, among terminals 10 currently in communication with base station 20, a terminal that is going to finish the communication is present (YES in S11), base station 20 performs update in such a manner that (Fⱼ, BWᵢ) which is allocated to the terminal that is going to finish the communication in Step S11, if not allocated to any other terminal in communication is deleted from the wireless spectrum map indicating the current allocation situation of base station 20 itself, which is stored (retained) in memory 220 (S12). In a case where (Fⱼ, BWᵢ) is allocated to any other terminal in communication, base station 20 does not delete (Fⱼ, BWᵢ) from the wireless spectrum map.

As described above, wireless communication system 1000 according to the present embodiment includes at least one terminal 10 and base station 20 that is capable of the wireless communication with terminal 10, which uses a high frequency band (for example, WiGig (a registered trademark) in the band of 57.24 to 65.88 GHz). When making a request for the communication with base station 20, terminal 10 generates the request for the communication that includes the terminal performance information (refer to FIGS. 6A and 6B) of terminal 10 itself, and transmits the generated request to base station 20. Base station 20 retains information relating to at least one already-allocated bandwidth, among all system bandwidths that are to be used for the wireless communication, in memory 220. Base station 20 determines whether the already-allocated bandwidth that is the same as the bandwidth which satisfies the terminal performance information of terminal 10 is present or absent, according to the request for the communication, which is transmitted from terminal 10. In a case where the already-allocated bandwidth that is the same as the bandwidth which satisfies the terminal performance information of terminal 10 is absent, base station 20 determines whether a non-allocated bandwidth that is the same as the bandwidth that satisfies the terminal performance information is present or absent. In a case where the non-allocated bandwidth that is the same as the bandwidth that satisfies the terminal performance information is present, base station 20 allocates the non-allocated bandwidth that is the same as the bandwidth that satisfies the terminal performance information, for the wireless communication with terminal 10.

Accordingly, base station 20 allocates the bandwidth that satisfies the terminal performance information of terminal 10 which has transmitted the request for the communication, among all system bandwidths (for example, the band of 57.24 to 65.88 GHz) that are available for the wireless communication (for example, WiGig (a registered trademark)), in such a manner as to be different from the already-allocated bandwidth. Because of this, it is possible that allocation of various types of carrier waves frequencies (more precisely, carrier wave central frequencies and bandwidths) is performed. Accordingly, base station 20 can abolish the constraint that the number of employed carrier wave frequencies that is based on the uniform allocation of carrier wave frequencies in current WiGig (a registered trademark) or IEEE 802.11ad should be small (specifically, 4). More precisely, it is possible that base station 20 occupies various carrier wave frequencies as illustrated in FIG. 5B or 8, and it is possible that a great number of carrier wave frequencies that are occupied are great compared with the wireless communication standard that is current WiGig (a registered trademark) or IEEE 802.11ad. Therefore, base station 20 can suppress the same channel interference when performing the wireless communication. Furthermore, the manufacturing of terminal 10 that realizes only the required throughput in accordance with an application that is used in terminal 10 can be made possible, and an increase in the cost of manufacturing terminal 10 and in maximum transmission power can be suppressed adaptively.

Furthermore, according to the present embodiment, because carrier wave frequencies are occupied variously, for example, even in a case where the backhaul line is configured with a multi-hop, the suitability is easily ensured regardless of a difference between the requires throughput of the wireless link at the origin (more precisely, the base station side that is connected directly to the core network) of the multi-hop path and the required throughput of the wireless link of the endpoint (more precisely, the base station side that needs a great number of hops to make a connection to the core network, which is farthest from a base station that is connected directly to the core network) on the multi-hop path. Accordingly, even in a case where multiple multi-hop paths are configured complicatedly, it is unnecessary that the same carrier wave frequency is allocated in the neighborhood, and the problem of the same channel interference is easy to avoid.

Furthermore, base station 20 allocates the non-allocated bandwidth that is the same as the bandwidth which satisfies the terminal performance information, for the wireless communication with terminal 10, and then updates the information relating to the already-allocated bandwidth, which is retained in memory 220. Accordingly, for the wireless communication with terminal 10, base station 20 uses the carrier wave frequency (more precisely, the carrier wave central frequency and the bandwidth) that has not yet been used (allocated) up to now. Because of this, the wireless spectrum map relating to a precise bandwidth is obtained by updating the information relating to the latest already-allocated bandwidth. Therefore, base station 20, for example, can precisely determine whether or not the allocation of the carrier wave frequency that satisfies the terminal performance information of the terminal is allocable to terminal 10 that has made the next new request for the communication.

Furthermore, in a case where the already-allocated bandwidth that is the same as the bandwidth that satisfies the terminal performance information is present, base station 20 determines whether or not the already-allocated bandwidth that is the same as the bandwidth that satisfies the terminal performance information is allocable for the wireless communication with terminal 10. In a case where it is determined that the already-allocated bandwidth that is the same as the bandwidth that satisfies the terminal performance information is allocable for the wireless communication with terminal 10, base station 20 allocates the already-allocated bandwidth that is the same as the bandwidth that satisfies the terminal performance information, for the wireless communication with terminal 10. Accordingly, if base station 20 can allocate the already-allocated carrier wave frequency (more precisely, the already-allocated carrier wave central frequency and bandwidth) on the time axis, based on the bandwidth that satisfies the terminal performance information of terminal 10 that has made a request for new communication, base station 20 performs allocation without causing any change. Thus, regarding the carrier wave frequency in all current system bandwidth, unnecessary occupation of the same carrier wave frequency for any other purpose can be avoided.

Furthermore, each time any terminal 10 that is being connected to base station 20 finishes the wireless communication with base station 20, base station 20 deletes the information relating to the bandwidth, which is allocated to any other terminal 10, from the information relating to the already-allocated bandwidth, which is retained in memory 220, and updates the information relating to the already-allocated bandwidth. Accordingly, due to terminal 10 that finishes the communication, base station 20 releases the carrier wave frequency (more precisely, the carrier wave central frequency and the bandwidth) that has been used (allocated) up to now. Because of this, the wireless spectrum map relating to a precise bandwidth is obtained by updating the information relating to the latest already-allocated bandwidth. Therefore, base station 20, for example, can determine whether or not the allocation of the carrier wave frequency that satisfies the terminal performance information of the terminal is allocable to terminal 10 that has made the next new request for the communication.

Furthermore, the terminal performance information has at least information relating to a bandwidth in which terminal 10 is operable. Accordingly, base station 20 can precisely determine whether or not a suitable carrier wave frequency can be allocated to terminal 10 that has transmitted the request for the transmission, considering in which bandwidth terminal 10 is operable.

Furthermore, the terminal performance information has information relating to required throughput that is needed for the communication from base station 20 to terminal 10. Accordingly, base station 20 can precisely determine whether or not a suitable carrier wave frequency can be allocated to terminal 10 that has transmitted the request for the communication, considering whether or not required throughput that is needed for transfer of data between terminal 10 and base station 20 is necessary (more precisely, how high a requested transfer speed is).

Various embodiments are described above with reference to the drawings, but it goes without saying that the present disclosure is not limited to the related examples. It is apparent to a person of ordinary skill that various modification examples or revision examples can be contemplated within the scope of a claim, and, of course, it is understood that these also justifiably fall within the technical scope of the present disclosure.

### INDUSTRIAL APPLICABILITY

The present disclosure is useful in implementing a base station, a bandwidth allocation method, a wireless communication system, and a terminal that are capable of allocating various bandwidths for wireless communication, of suppressing the same channel interference when performing the wireless communication, and of adaptively suppressing an increase in the cost of manufacturing the terminal or in maximum transmission power.

### REFERENCE MARKS IN THE DRAWINGS

10, 10A, 10B, 10C, 10D TERMINAL
20 BASE STATION
101, 116, 201, 216 IF UNIT
102, 202 TRANSMISSION BASEBAND SIGNAL PROCESSING UNIT
103, 2031, 203n DAC
104, 2041, 204n MODULATION UNIT
105, 2051, 205n UP-CONVERTER
106, 2061, 206n PA
107, 110, 2071, 207n, 2101, 210n BPF
108, 208 DUPLEXER
109, 209 ANTENNA
111, 2111, 211n LNA
112, 2121, 212n DOWN-CONVERTER
113, 2131, 213n DEMODULATION UNIT
114, 2141, 214n ADC
115, 215 RECEPTION BASEBAND SIGNAL PROCESSING UNIT
117, 217 COMMUNICATION CONTROL CPU
118, 218 CLOCK GENERATION UNIT
119, 219 CRYSTAL OSCILLATOR
120, 220 MEMORY
221 POWER COMBING UNIT
1000 WIRELESS COMMUNICATION SYSTEM
CE1 SMALL CELL

1. A base station that is capable of wireless communication that uses a high frequency band, the base station comprising:
a memory in which information relating to at least one already-allocated bandwidth, among all bandwidths that are to be used for the wireless communication, is retained; and
a processor that
determines whether the already-allocated bandwidth that is the same as a bandwidth which satisfies terminal performance information is present or absent, according to a request for communication from a terminal, which includes the terminal performance information,
determines whether a non-allocated bandwidth that is the same as the bandwidth which satisfies the terminal performance information is present or absent, in a case where the already-allocated bandwidth that is the same as the bandwidth which satisfies the terminal performance information is absent, and
allocates the non-allocated bandwidth that is the same as the bandwidth which satisfies the terminal performance information, for the wireless communication with the terminal, in a case where the non-allocated bandwidth that is the same as the bandwidth which satisfies the terminal performance information is present.

2. The base station of claim 1,
wherein the processor allocates the non-allocated bandwidth that is the same as the bandwidth which satisfies the terminal performance information, for the wireless communication with the terminal, and then updates information relating to the already-allocated bandwidth, which is retained in the memory.

3. The base station of claim 1,
wherein the processor
determines whether or not the already-allocated bandwidth that is the same as the bandwidth which satisfies the terminal performance information is allocable for the wireless communication with the terminal, in the case where the already-allocated bandwidth that is the same as the bandwidth which satisfies the terminal performance information is present, and
allocates the already-allocated bandwidth that is the same as the bandwidth which satisfies the terminal performance information, for the wireless communication with the terminal, in a case where it is determined that the already-allocated bandwidth that is the same as the bandwidth which satisfies the terminal performance information is allocable for the wireless communication with the terminal.

4. The base station of claim 1,
wherein the processor deletes information relating to a bandwidth that is allocated to any other terminal, from the information relating to the already-allocated bandwidth, which is retained in the memory, and updates the information relating to the already-allocated bandwidth, each time the terminal that is being connected to the base station finishes the wireless communication with the base station.

5. The base station of claim 1,
wherein the terminal performance information has at least information relating to a bandwidth in which the terminal is operable.

6. The base station of claim 5,
wherein the terminal performance information further has information relating to required throughput that is needed for communication from the base station to the terminal.

7. A bandwidth allocation method in a base station that is capable of wireless communication that uses a high frequency band, the method comprising:
a step of retaining information relating to at least one already-allocated bandwidth, among all bandwidths that are to be used for the wireless communication, in a memory;
a step of determining whether the already-allocated bandwidth that is the same as a bandwidth which satisfies terminal performance information is present or absent, according to a request for communication from a terminal, which includes the terminal performance information;
a step of determining whether a non-allocated bandwidth that is the same as the bandwidth which satisfies the terminal performance information is present or absent, in a case where the already-allocated bandwidth that is the same as the bandwidth which satisfies the terminal performance information is absent; and
a step of allocating the non-allocated bandwidth that is the same as the bandwidth which satisfies the terminal performance information, for the wireless communication with the terminal, in a case where the non-allocated bandwidth that is the same as the bandwidth which satisfies the terminal performance information is present.

8. A wireless communication system comprising:
at least one terminal; and
a base station that is capable of wireless communication with the terminal, which uses a high frequency band,
wherein the terminal transmits a request for communication, which includes terminal performance information of the terminal itself, to the base station, and
wherein the base station
retains information relating to at least one already-allocated bandwidth, among all bandwidths that are to be used for the wireless communication, in a memory,
determines whether the already-allocated bandwidth that is the same as a bandwidth which satisfies the terminal performance information is present or absent, according to the request for the communication, which is transmitted from the terminal,
determines whether a non-allocated bandwidth that is the same as the bandwidth which satisfies the terminal performance information is present or absent, in a case where the already-allocated bandwidth that is the same as the bandwidth which satisfies the terminal performance information is absent, and
allocates the non-allocated bandwidth that is the same as the bandwidth which satisfies the terminal performance information, for the wireless communication with the terminal, in a case where the non-allocated bandwidth that is the same as the bandwidth which satisfies the terminal performance information is present.

9. A terminal that wirelessly communicates with a base station that is capable of the wireless communication that uses a high frequency band, the terminal comprising:
a memory in which terminal performance information of the terminal itself that includes information relating to a bandwidth in which the terminal is operable, among all bandwidths that are to be used for the wireless communication, is retained;
a processor that generates a request for communication with the base station, which includes the terminal performance information of the terminal itself; and
a communication unit that transmits the request for communication to the base station,
wherein, in the base station, it is determined whether an already-allocated bandwidth that is the same as a bandwidth which satisfies the terminal performance information is present or absent,
in a case where the already-allocated bandwidth that is the same as the bandwidth which satisfies the terminal performance information is absent, it is determined whether or not a non-allocated bandwidth that is the same as the bandwidth which satisfies the terminal performance information is present or absent, and
in a case where the non-allocated bandwidth that is the same as the bandwidth which satisfies the terminal performance information is present, the communication unit receives information relating to the non-allocated bandwidth that is the same as the bandwidth which satisfies the terminal performance information, which is transmitted from the base station, and
wherein the processor sets information relating to a bandwidth for the wireless communication with the base station, using the information relating to the non-allocated bandwidth that is the same as the bandwidth which satisfies the terminal performance information, which is transmitted from the base station.
